(19) United States
(12) Patent Application Publication
(10) Pub. No.: US 2016/0210257 A1
(43) Pub. Date: Jul. 21, 2016

(54) COMMUNICATION CONTROLLER FOR ELECTRONIC DEVICES

(71) Applicant: NANOPORT TECHNOLOGY INC., Markham (CA)

(72) Inventor: Timothy Jing Yin SZETO, Markham (CA)

(73) Assignee: Nanoport Technology Inc.

(21) Appl. No.: 14/988,296

(22) Filed: Jan. 5, 2016

Related U.S. Application Data
(60) Provisional application No. 62/099,941, filed on Jan. 5, 2015.

(51) Int. Cl. G06F 13/40; G06F 13/364; G06F 13/42

(52) U.S. Cl. CPC G06F 13/4022; G06F 13/4282; G06F 13/364

(57) ABSTRACT

A communication controller for an electronic device comprises a hub controller; an internal port for connecting to an I/O interface of the electronic device, external ports for connection to other electronic devices, a switching circuit for connecting a device at any port as a host, with slave devices at other ports. The switching circuit can switch between: a first state connecting the electronic device as host with other electronic devices connected as slave devices, a second state with a first other electronic device at a first external port as host and the electronic device and a second other electronic device as a slave devices, and a third state with the second other electronic device at a second external port as host and the electronic device and the first other electronic device as a slave devices. The controller has a control input for selecting between states.

### CROSS-REFERENCE TO RELATED APPLICATIONS

This application claims priority from U.S. provisional patent application No. 62/099,941, filed Jan. 5, 2015, the entire contents of which are incorporated herein by reference.

### FIELD

This disclosure relates to a communication controller for electronic devices, and more particularly, to a communication controller for dynamic assignment of host and slave roles amongst electronic devices.

### BACKGROUND

Communication hubs allow for interconnection of electronic devices. For example, a Universal Serial Bus (USB) hub allows a host device to connect to a plurality of slave devices, and allows the host device to send data to and/or receive data from each of the slave devices by way of the hub.

The host device may, for example, be a computer, and the slave devices may, for example, be various peripheral devices. Peripheral devices may include, for example, a camera, a printer, an external hard drive, etc.

However, this interconnection of electronic devices may not provide sufficient flexibility in some circumstances.

### SUMMARY

In accordance with an aspect, there is provided a communication controller. The communication controller includes a plurality of ports, each configured for interconnection with an electronic device of a plurality of electronic devices, and each selectively configurable to function as a slave port or a host port; and an input for receiving a control signal, the control signal identifying a given port of the plurality of ports to function as a host port. The controller, upon receiving the control signal, configures the given port to function as a host port, and other ports of the plurality of ports to function as slave ports, thereby assigning host and slave roles amongst the plurality of electronic devices.

In accordance with another aspect, there is provided an electronic device. The electronic device includes a communication controller. The communication controller includes a plurality of ports, each configured for interconnection with one of the electronic device and a plurality of other electronic devices, and each selectively configurable to function as a slave port or a host port; and an input for receiving a control signal, the control signal identifying a given port of the plurality of ports to function as a host port. The controller, upon receiving the control signal, configures the given port to function as a host port, and other ports of the plurality of ports to function as slave ports, thereby assigning host and slave roles amongst the electronic device and the other electronic devices.

In accordance with another aspect, there is provided a communication controller for an electronic device, comprising: a hub controller; an internal port for connecting to an I/O interface of the electronic device; at least two external ports for connection to external electronic devices by way of corresponding connectors on a housing of the electronic device; a switching circuit for selectively connecting a device at any given one of the internal port and the external ports, as a host device, with other devices at remaining ones of the internal and external ports as slave devices; wherein the switching circuit is configured to switch between: a first state in which the switching circuit connects the electronic device at the internal port as a host device with a first external device at a first one of the external ports as a slave device, and with a second external device at a second one of the external ports as a slave device; a second state in which the switching circuit connects the first external device at the first one of the external ports as a host device, with the electronic device at the internal port as a slave device, and with the second external device at the second one of the external ports as a slave device; and a third state in which the switching circuit connects the second external device at the second one of the external ports as a host device, with the electronic device at the internal port as a slave device, and with the first external device at the first one of the external ports as a slave device; and a control input for receiving a control signal from a processor of the electronic device to select one of the first, second and third states.

The communication controller may be part of an electronic device, such as a smartphone.

In accordance with another aspect, there is provided a method of operating a communication hub of an electronic device, comprising; connecting a plurality of external devices to the communication hub; receiving a control input from a processor of the electronic device; assigning, based on the control input, the electronic device or one of the plurality of external devices as a host; assigning the others of the electronic device and the plurality of electronic devices as slaves; connecting the slaves in communication with the host by way of a switching circuit.

In accordance with another aspect, there is provided a communication controller for an electronic device, comprising: a hub controller; an internal port for connection to an I/O interface of the electronic device; a plurality of external ports for connection to external electronic devices by way of corresponding connectors on a housing of the electronic device; a switching circuit for selectively connecting a device at any first one of the internal port and the external ports, as a host device, with another device at any second one of the internal and external ports as a slave device; and a control input for receiving a control signal from a processor of the electronic device for selection of the first one of the internal port and the external ports.

Many further features and combinations thereof concerning embodiments described herein will appear to those skilled in the art following a reading of the instant disclosure.

### DESCRIPTION OF THE FIGURES

In the figures,

FIGS. 1A, 1B and 1C are perspective views of electronic devices in various configurations;

FIG. 2 is a schematic diagram of a communication hub;

FIG. 3 is a schematic diagram of a communication hub, according to an embodiment;

FIG. 4 is a more detailed schematic diagram of the communication hub of FIG. 2, according to an embodiment;

FIG. 5A is a schematic diagram of the communication hub of FIG. 2, for an example assignment of host and slave roles, according to an embodiment;

FIG. 5B is a schematic diagram of the communication hub of FIG. 2, for another example assignment of host and slave roles, according to an embodiment;

FIG. 6 is a schematic diagram of an electronic device including an integrated communication hub, according to an embodiment;

FIG. 7A is a schematic diagram of the electronic device interconnected with other electronic devices, for an example assignment of host and slave roles, according to an embodiment;

FIG. 7B is a schematic diagram of the electronic device interconnected with other electronic devices, for another example assignment of host and slave roles, according to an embodiment;

FIGS. 8A-8B are perspective views of electronic devices including integrated communication hubs, in two different configurations; and

FIG. 9 is a front view of the electronic devices of FIG. 7A/7B, cooperating to display an image, according to an embodiment.

### DETAILED DESCRIPTION

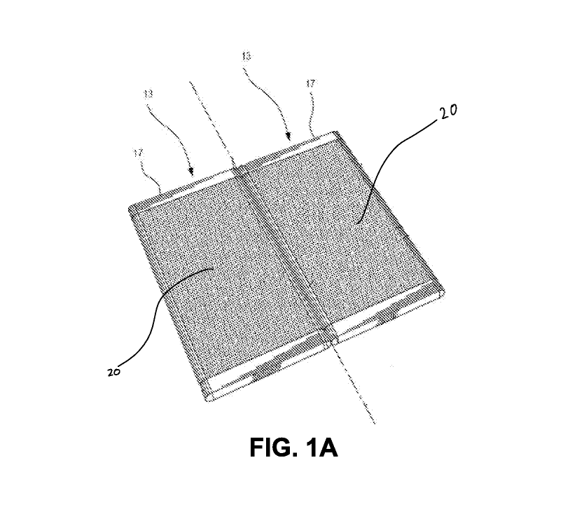

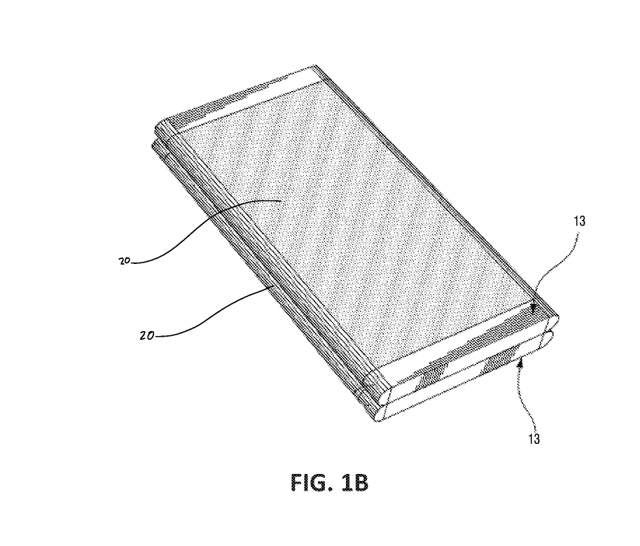

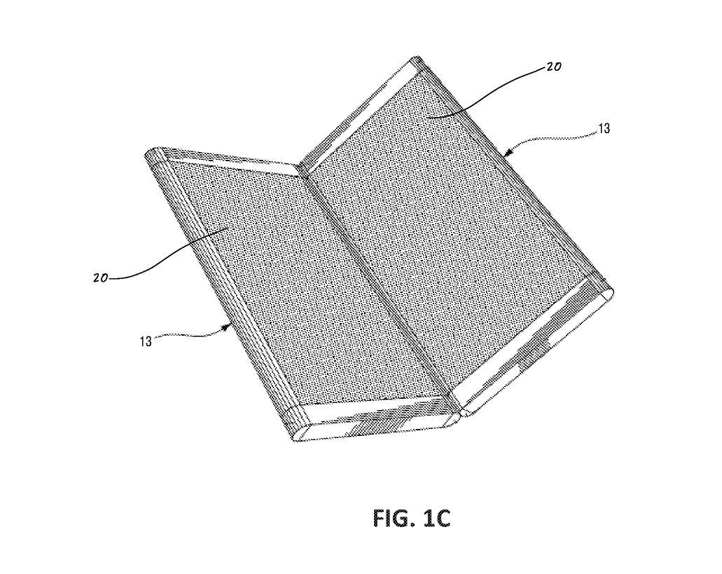

Referring to FIGS. 1A, 1B and 1C, a pair of electronic devices 20 each include a housing 13 defined by contiguous external surfaces 17. The devices 20 may be any electronic devices that interface with one another and provide complementary functions. As depicted, each device is a smartphone. In other embodiments, one device may be smartphone and the other an accessory, such as a speaker. As further examples, one of the devices may be a smartphone and the other a viewing screen, or both may be viewing screens, or one may be a screen and the other a keyboard; one device may be a touchscreen enabled device and the other a router to communicate to the Internet, or one may be a camera and the other a smart phone to store images from the camera. These examples are non-limiting and it will be apparent that many mutually complementary devices exist that benefit from interconnection and interoperation.

As shown in FIG. 1A, the devices 20 may be arranged side by side with a pair of surfaces 17, e.g. lateral surfaces, juxtaposed, typically when in use, or, as shown in FIG. 1B, in a stacked configuration with a different pair of surfaces, e.g. front and back surfaces, juxtaposed for storage or for alternative functions.

Devices 20 include connectors at each corner of their respective housings, so that the devices may be used together. For example, two devices may be placed side-by-side, with lateral surfaces 17 abutting and connectors engaged with one another, as shown in FIG. 1A. Devices 20 may be used in such a configuration, for example, to cooperatively render or display content using displays of both devices 20. Devices may also be placed on top of one another, so that a top or bottom surface of one device abuts a top or bottom surface of another device as shown in FIG. 1B. Such configuration may, for example, be used where one device 20 is a smartphone and another device 20 is a storage device. In some embodiments, devices may be placed side-by-side and pivoted relative to one another, as shown in FIG. 10. Such movement of devices may cause changes in functioning modes of the devices 20. For example, pivoting devices 20 from the position of FIG. 1B to the position of FIG. 10 may cause displays of both devices to become active for cooperatively displaying content.

Devices 20 may be interconnected during operation to transmit data to one another. During operation, one device 20 may act as a host and the other may act as a slave. In some embodiments, the host-slave relationship may switch depending on the function or functions being performed. Therefore, each of the devices may include a hub for managing data flow with a host-slave relationship in either direction.

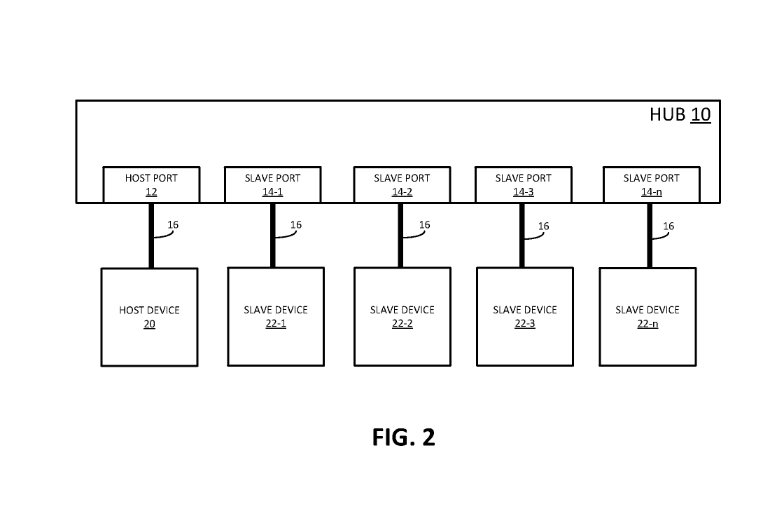

FIG. 2 illustrates a communication hub 10. Hub 10 may, for example, be a USB hub. Hub 10 includes a host port 12 and a plurality of slave ports 14-1, 14-2, 14-3, . . . 14-n, which may be referred to individually as a slave port 14 and collectively as slave ports 14.

Each host port 12 and slave port 14 is configured for interconnection with an electronic device. In particular, host port 12 is configured for interconnection with a host device 20. Each slave port 14 is configured for interconnection with one of a plurality of slave devices 22-1, 22-2, 22-3, . . . 22-n, which may be referred to individually as a slave device 22 and collectively as slave devices 22.

Host device 20 may be, for example, a computer, and each slave device 22 may be, for example, a peripheral device. Each host port 12 and slave port 14 may be connected to a respective host device 20 or slave device 22 by way of a link 16, which may comprise one or more connectors, sockets, cables, etc., or a combination thereof.

When host device 20 and slave devices 22 are interconnected through hub 10, host device 20 may communicate with one or more of slave devices 22. Host device 20 may perform various functions of a USB host, e.g., enumerate slave devices 22, control a slave device 22, receive data from a slave device 22, transmit data to a slave device 22, supply power to a slave device 22, etc.

One limitation of hub 10 is that the host and slave roles of devices 20 and 22 are determined by the port of hub 10 to which they are connected. For example, device 20 is assigned a host role as a consequence of being connected to host port 12. Similarly, each device 22 is assigned a slave role as a consequence of being connected to a slave port 14. Re-assignment of roles (e.g., from slave to host, or host to slave), requires a device 20/22 to be disconnected from hub 10, and reconnected to another port. The need for disconnection/reconnection may be undesirable when the roles of devices 20/22 need to change dynamically during operation, e.g., under software control, without user intervention, etc.

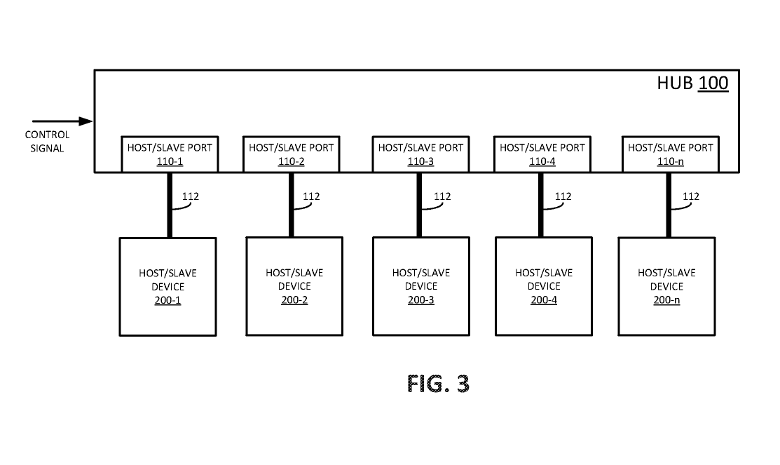

FIG. 3 illustrates a communication controller 100 (which may also be referred to as hub 100) according to an embodiment. Communication controller 100 includes a plurality of bi-directional host/slave ports 110-1, 110-2, 110-3, . . . 110-n, which may be referred to individually as a host/slave port 110 and collectively as host/slave ports 110.

Each host/slave port 110 is configured for interconnection with an electronic device. In particular, each host/slave port 110 is configured for interconnection with one of a plurality of host/slave devices 200-1, 200-2, 200-3, 200-4,. . . 200-n, which may be referred to individually as a host/slave device 200 and collectively as host/slave devices 200. Each host/slave port 110 may be connected to a respective host/slave device 200 by way of a link 112, which may comprise one or more connectors, sockets, cables, etc., or a combination thereof.

Each host/slave port 110 and each link 112 may adhere to the USB standard, e.g., as defined in USB Specifications 1.x, 2.x, or 3.x, the contents of each of which are hereby included by reference herein.

Host/slave devices 200 include electronic devices configured to function as host devices (e.g., a computer), electronic devices configured to function as slave devices (e.g., a peripheral device), and electronic devices configured to function, selectively, as a host device or a slave device, as described below.

Further, each host/slave port 110 is configured to function, selectively, as either a host port or a slave port. So, each host/slave port 110 may be connected to an electronic device 200 configured to function as a slave device, or an electronic device 200 configured to function as a host device.

Communication controller 100 also includes an input for receiving a control signal. The control signal identifies a given port 110 of the plurality of host/slave ports 110 to function as a host port. The control signal may identify the given port 110 by including an identifier of that port. The control signal may also identify the given port 110 by including an identifier of the electronic device connected to that port. The control signal may be received by way of a port 110. The control signal may be received by way of a wireless interface.

During operation, communication controller 100, upon receiving a control signal, configures the given port 110 to function as a host port, and configures other ports 110 to function as slave ports. The electronic device 200 connected to the given port 110 may then be configured to function as a host device. Meanwhile, the electronic devices 200 connected to other ports 110 may be configured to function as slave devices. In this way, communication controller 100 assigns host and slave roles amongst the plurality of electronic devices 200.

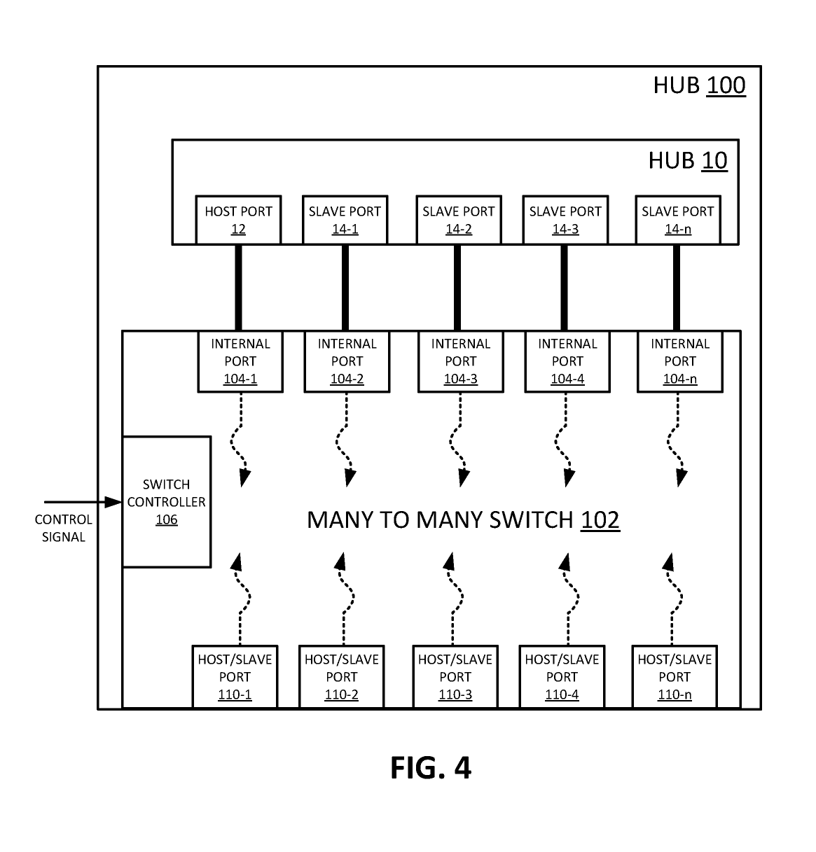

FIG. 4 provides a more detailed schematic view of communication controller 100, according to an embodiment. As depicted, communication controller 100 includes hub 10 and a many-to-many switch 102.

Hub 10 may be a conventional USB hub, as depicted, for example in FIG. 1. In a specific embodiment, hub 10 may include a conventional USB hub controller chip. In the depicted embodiment, hub 10 includes a host port 12 and slave ports 14, described above with reference to FIG. 1.

Switch 102 includes a plurality of bi-directional ports 104-1, 104-2, 104-3, . . . 104-n, which may be referred to individually as a port 104 and collectively as ports 104. Each port 104 may be connected to a host port 12 or a slave port 14 of hub 10. As depicted, port 104-1 is connected to host port 12, and the remainder of the ports 104, i.e., ports 104-2, 104-3, 104-4, . . . 104-n, are connected to a respective slave port 14.

Switch 102 also includes host/slave ports 110, described above with reference to FIG. 3. As noted, each host/slave port 110 is configured for interconnection with a host/slave device 200.

Switch 102 may be a conventional switch providing selectable bi-directional communication paths through the switch 102, each path connecting a port 104 with a host/slave port 110. In this way, each host/slave port 110 may be selectively connected to host port 12 or a slave port 14. Selection of these paths is controlled by switch controller 106, which performs the selection according to a control signal received by controller 100. In one specific embodiment, switch 102 may include a conventional mux-demux chip.

When a given host/slave port 110 is connected to host port 12, that host/slave port 110 may function as a host port. A host/slave device 200 connected to the given (host) port 110 may be configured to function as a host device. Conversely, when a given host/slave port 110 is connected to a slave port 12, that host/slave port 110 may function as a slave port. A host/slave device 200 connected to the given (slave) port 110 may be configured to function as a slave device.

The paths may be changed dynamically during operation, thereby allowing the slave/host roles of devices 200 to be assigned dynamically during operation, e.g., under software control. For example, a device 200 may be assigned a new host/slave role and transition to this new role dynamically. For example, a device 200 may transition from a host role to a slave role, or vice versa. Conveniently, roles may be assigned, and may change without disconnecting/reconnecting any device 200. Conveniently, roles may be assigned, and may change without user intervention.

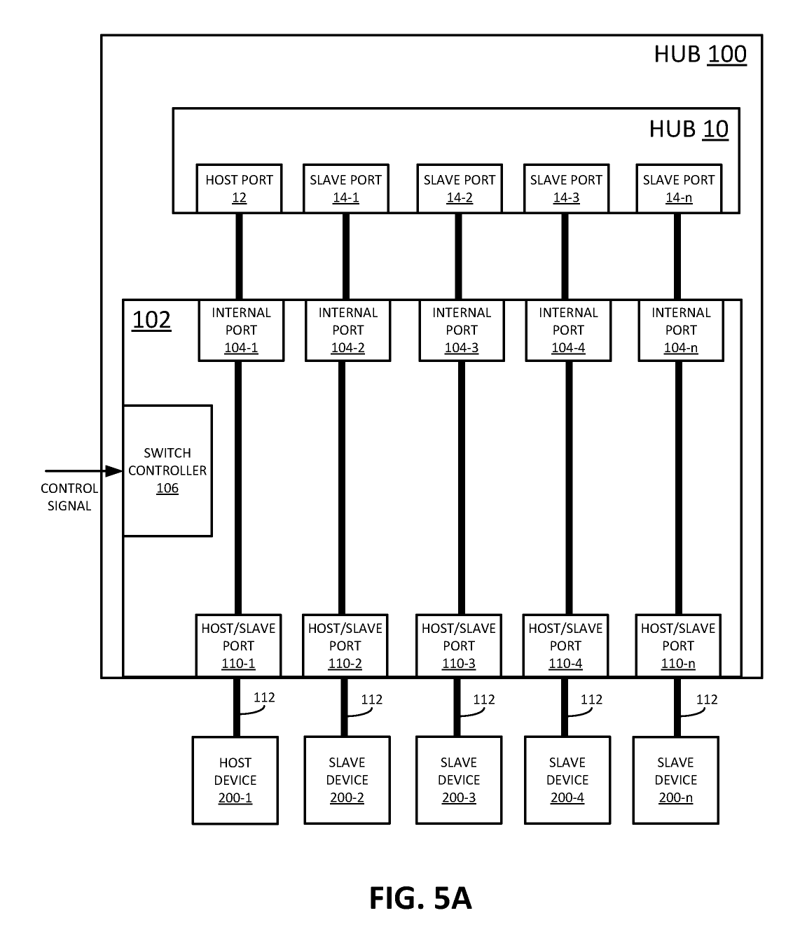

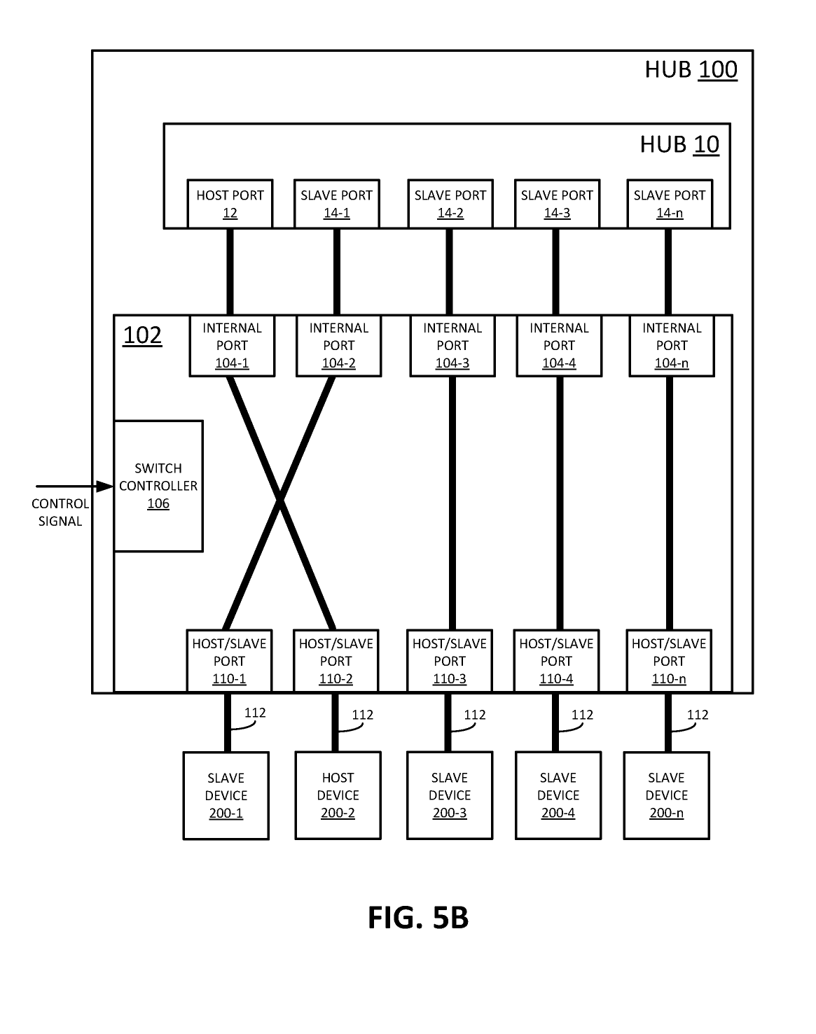

FIG. 5A shows a possible selection of paths in switch 102, according to an embodiment. As shown, port 104-1 is connected with host port 12 of hub 10, as well as host/slave port 110-1. So connected, host/slave port 110-1 may function as a host port, and device 200-1 connected with port 110-1 may function as a host device.

This selection of paths may be changed by switch controller 106, e.g., upon request through a control signal. For example, switch controller 106 may receive a control signal requesting that host/slave port 110-2 be connected to port 104-1.

In response, switch controller 106 may change the selected paths to that shown in FIG. 5B. As depicted, host/slave port 110-2 is connected to port 104-1 and may function as a host port, while the remaining host/slave ports 110 are connected to the remaining ports 104, and may function as slave ports. Consequently, host/slave device 200-1 may transition from functioning as a host device to functioning as a slave device (e.g., a slave of device 200-2). Meanwhile, host/slave device 200-2 may transition from functioning as a slave device to functioning as a host device (e.g., a host of device 200-1).

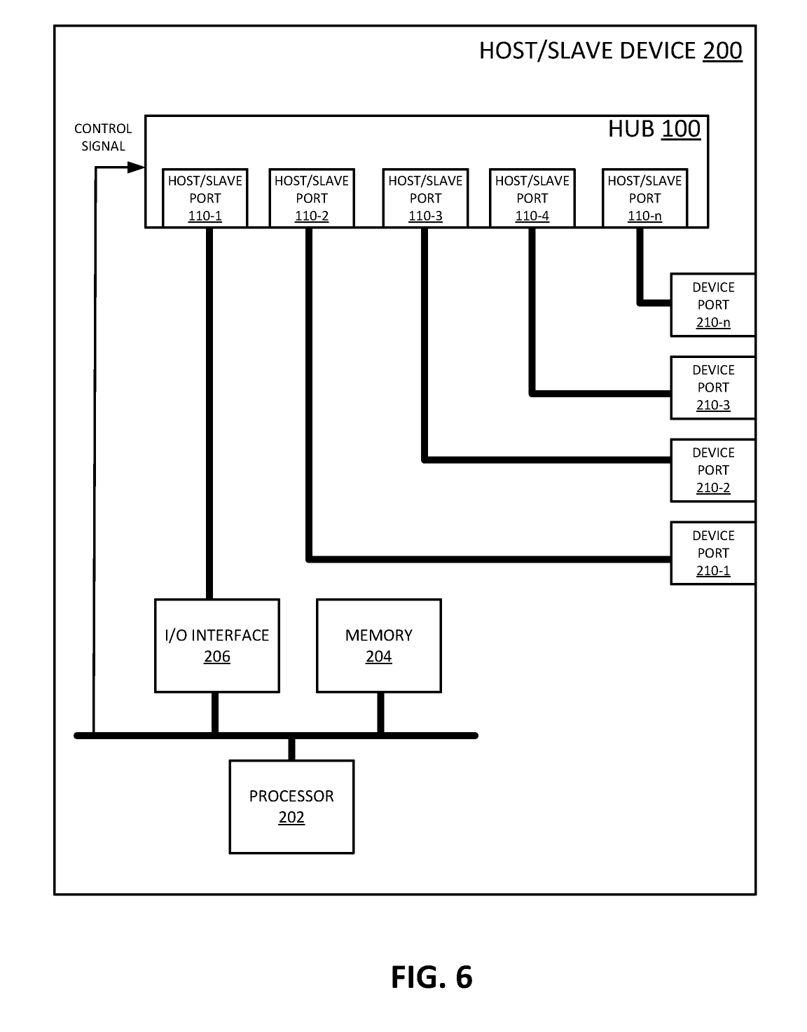

FIG. 6 depicts a host/slave device 200 that includes an integrated communication controller 100, according to an embodiment.

Device 200 may, for example, be a smart phone, tablet computer, laptop computer, desktop computer, workstation, server, portable computer, personal digital assistant, interactive television, video display terminal, gaming console, electronic reading device, any other portable electronic device, or a combination of these. Device 200 may be integrated with a household appliance (e.g., a fridge, oven, washing machine, stereo, exercise bike, alarm clock, or the like), or a vehicle (e.g., on a vehicle dashboard), etc.

As depicted, device 200 includes a communication controller 100, one or more processors 202, memory 204, one or more I/O interfaces 206, and a plurality of device ports 210-1, 210-2, 210-3, . . . 210-n, which may be referred to individually as a device port 210 and collectively as device ports 210.

Each processor 202 may be any type of processor, such as, for example, any type of general-purpose microprocessor or microcontroller, a digital signal processing (DSP) processor, an integrated circuit, a field programmable gate array (FPGA), a reconfigurable processor, or any combination thereof.

Memory 204 may be any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

I/O interfaces 206 allow device 200 to communicate with other devices, e.g., by way of device ports 210, or by way of a wireless link (e.g., WiFi, Bluetooth, NFC, infra-red, etc.).

As shown, at least one I/O interface 206 (e.g., a USB interface) is connected with host/slave port 110-1 of controller 100.

Each device port 210 may, for example, be a USB port with connector pins exposed to the exterior of device 200, allowing for interconnection with another device. Each device port 210 is connected with a respective host/slave port 110 of controller 100, i.e., one of host/slave port 110-2, 110-3, 110-4, . . . 110-n.

Thus, host/slave port 110-1 is connected directly to an internal I/O interface 206 of device 200. Conversely, each of host/slave ports 110-2, . . . 110-n may be connected to another device, i.e. a device external to device 200. Accordingly, host/slave port 110-1 may be referred to as an internal port and host/slave ports 110-2, . . . 110-n may be referred to as external ports.

In an embodiment, host/slave device 200 may include control logic. In an embodiment, the control logic may be in the form of instructions stored in memory 204, executable at one or more processors 202. In another embodiment, the control logic may be in the form of a logic circuit.

This control logic is configured to generate a control signal for controlling hub 100, i.e., to select which host/slave port 110 functions as a host port, and which ports 110 to function as slave ports. When host/slave port 110-1 (interconnected with I/O interface 106) is selected to function as a host port, host/slave device 200 may be configured to function as a host device. When another one of host/slave ports 110 (e.g., a given port 110 connected to a given device port 210), then host/slave device 200 may be configured to function as a slave device. In this situation, another external electronic device connected to the given device port 210 may be configured to function as a host device (e.g., a host of device 200). One or more other external electronic devices may also be connected as additional slave devices.

Thus, hub 100 may operate in one of at least three possible states. In a first state, the hub may connect device 200, as a host device with first and second other devices connected to device ports 210-1, 210-2, as slave devices. In a second state, the hub may connect a first other device at device port 210-1 as a host device, with device 200 and a second other device at device port 210-2, as slave devices. In a third state, the hub may connect the second other device at device port 210-2 as a host device, with device 200 and the first other device at device port 210-1, as slave devices.

The control logic may, for example, be executed by processor 202 and a control signal may be provided to hub 100 by way of a control line 203.

Control line 203 may be connected to an output pin of processor 202, such as a general purpose input-output (GPIO) pin.

The control logic executed by processor 202 may take into account signals received from applications at device 200 or signals received from other devices. For example, certain applications running at device 200 may mandate that the device be assigned the host role in any connection to another device. In other examples, devices may communicate with one another (e.g. wirelessly using Bluetooth, near-field communication (NFC), Wi-Fi or the like) to determine a selection of a host device.

In some embodiments, the control signal on control line 203 may exclusively determine the host-slave arrangement of ports 110. In other embodiments, the control signal may be used with other inputs, variables, pre-determined parameters, or the like to determine the host-slave arrangement. For example, the control signal may indicate whether device 200 is able to assume the host role. Other signals may indicate applications running at other connected devices and, in particular, whether a connected device is running an application or instruction that requires host status. If so, the hub may assign such a device to act as host.

Other signals may, for example, be received wirelessly or through connections to ports 110.

So, communication controller 100 allows host/slave roles to be dynamically assigned to device 200, and other devices interconnected by way of device ports 210.

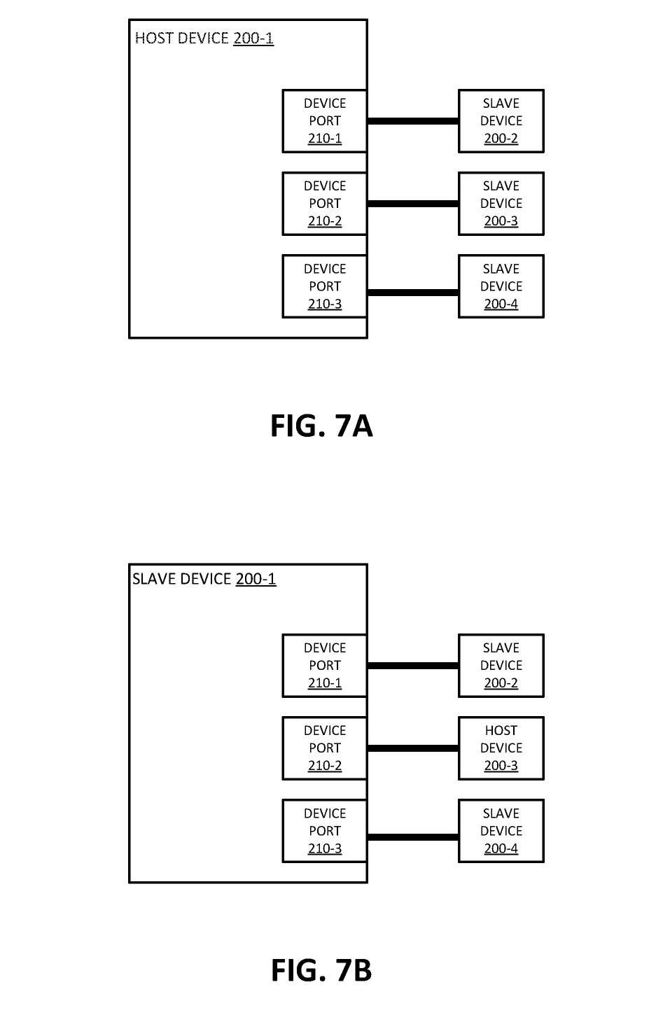

FIG. 7A illustrates one example assignment of host/slave roles for host/slave devices 200-1, 200-2, 200-3, 200-4, each of which may be configured as shown in FIG. 6. As shown, host/slave devices 200-1 is configured to function as a host device, and host/slave devices 200-2, 200-3, and 200-4 are each configured to function as a slave device (i.e., a slave of device 200-1).

These roles may change dynamically, e.g., as controlled by the above-noted control logic at each respective device 200-1, 200-2, 200-3, and 200-4. FIG. 7B illustrates another example assignment of host/slave roles for host/slave devices 200-1, 200-2, 200-3, and 200-4. As shown, host/slave device 200-3 is configured to function as a host device, and host/slave devices 200-1, 200-2, and 200-4 are each configured to function as a slave device (i.e., a slave of device 200-3).

The control logic of a device 200 (e.g., device 200-1) may be configured to select roles upon communicating with other interconnected devices 200 (e.g., devices 200-2, 200-2, 200-3). So, the control logic may be configured to conduct any hand-shaking required to establish communications with other devices 200, and to negotiate with those other devices 200 regarding roles to be played, e.g., which device should function as the host device. Such communications may be conducted by way of device ports 210, or by way of a wireless interface.

Thus, assignment and re-assignment of host/slave roles may occur without connecting or disconnecting devices from hub 100.

In an embodiment, the control logic may be configured to establish a schedule for selecting roles, e.g., to assign particular devices 200 as a host device at scheduled times.

In an embodiment, the control logic may be configured to select roles in response to a user request, or in response to a particular application being executed at a particular device, or in response to particular data being processed at a particular device.

In an embodiment, host/slave roles may be dynamically assigned in dependence on functions being performed at the devices. For example, host/slave roles may be assigned under software control using software control line 203.

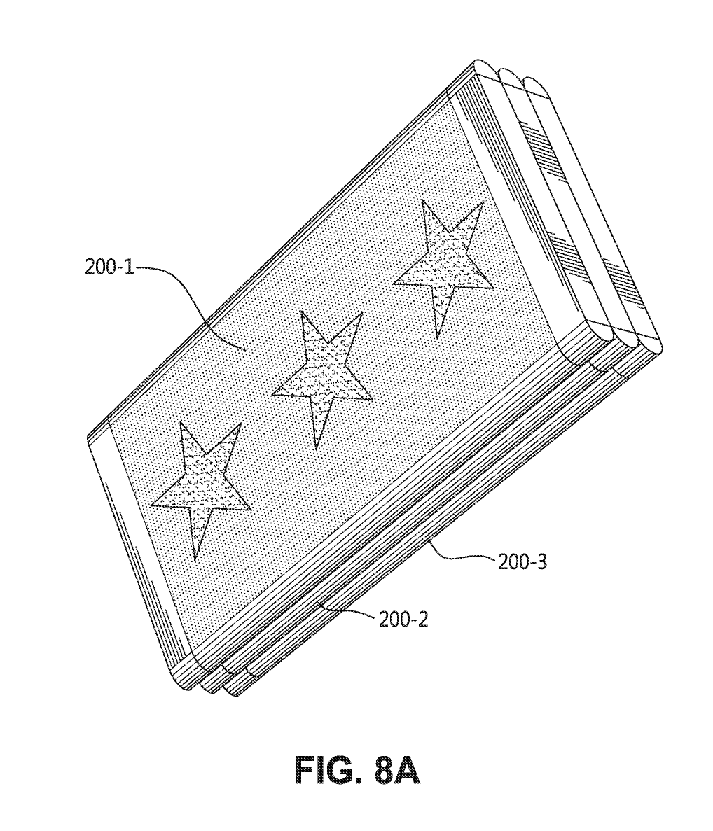

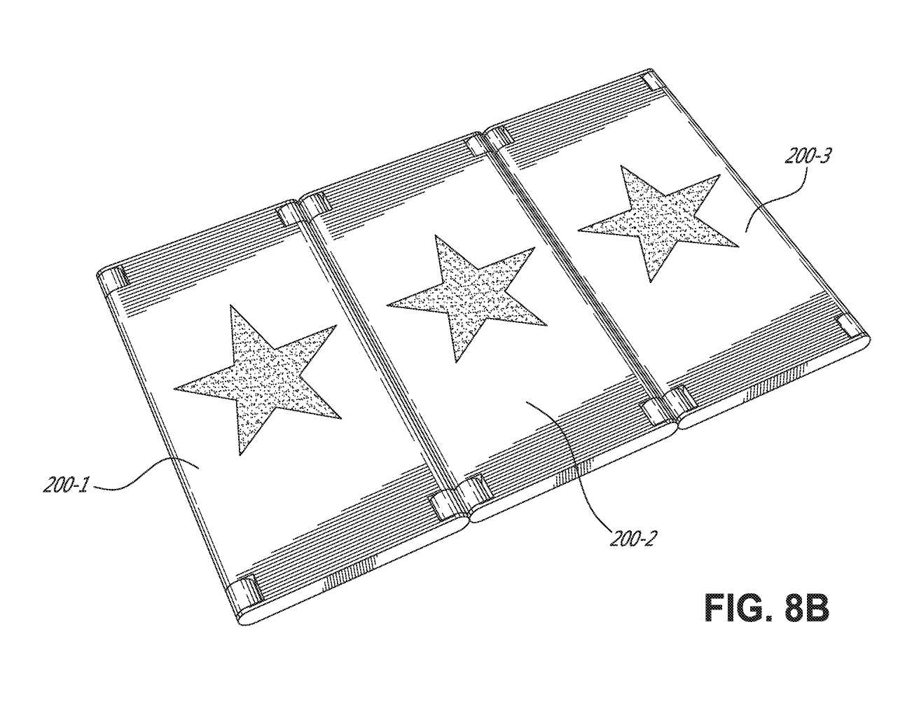

FIG. 8A depicts an example embodiment comprising three devices 200-1, 200-2, 200-3 (individually and collectively, devices 200). As depicted, the devices 200 may be positioned in a stack, with front and rear interfaces abutting one another. A front device 200-3 may include a camera module and may be positioned so that the camera module faces a subject to be photographed. A rear device 200-1 may be positioned so that its display faces a user. In such configuration, front device 200-3 may be configured as host and other devices 200-1, 200-2 may be assigned as slaves. Storage on device 200-1 may be exposed to host device 200-3 such that device 200-3 can capture an image and store it on device 200-1. Device 200-1 may then present the captured image on its display, e.g., under control of front device 200-3 acting as host. Devices 200-1, 200-3 may be connected to one another through a hub 100 (not shown) of device 200-2. In some embodiments, hub 100 of device 200-2 may operate while device 200-2 is in a relatively low-power consumption mode such as a sleep or hibernate mode. In the example depicted in FIG. 8A, it may be desirable to place device 200-2 in such a low-power consumption mode given that device 200-2 presents limited user-accessible interface elements due to its position in the stack of devices 200. In such case, devices 200-1 and 200-3 continue to operate in the above-described manner and are able to communicate through a communication bus (e.g. USB) established through hub 100 of device 200-2.

After capturing an image, a user may wish to review the image. To do so, the user may pivot devices 200-1, 200-2, 200-3 to a position such that the displays are oriented side-by-side and facing the user as shown in FIG. 8B. The devices 200 may then cooperatively present the captured image. Device 200-1, at which the images is stored, may be assigned as the host and devices 200-2, 200-3 may be assigned as slaves. Since device 200-1 hosts the captured image, it may send to each of devices 200-2, 200-3 instructions for rendering part of the image.

Devices 200-1, 200-2, 200-3 may communicate with one another to effect re-assignment of host/slave roles. For example, devices 200-1, 200-2, 200-3 may send messages to one another indicative of launching or closing of applications, invoking of modes by a user, change of orientation, or the like. Such messages may be sent by way of their respective connections to hub 100. Alternatively, messages may be sent wirelessly, e.g. using Bluetooth, near-field communication, Wi-Fi or the like. Each device 200 may control its respective hub 100 based at least partly on received messages. For example, upon transitioning devices 200-1, 200-2, 200-3 to the state of FIG. 8B and invoking of a picture display mode at device 200-1, device 200-1 may send a message to device 200-3 requesting host status. In response, device 200-3 may send a control signal to its hub 100 over control line 203 causing reassignment of host/slave roles accordingly.

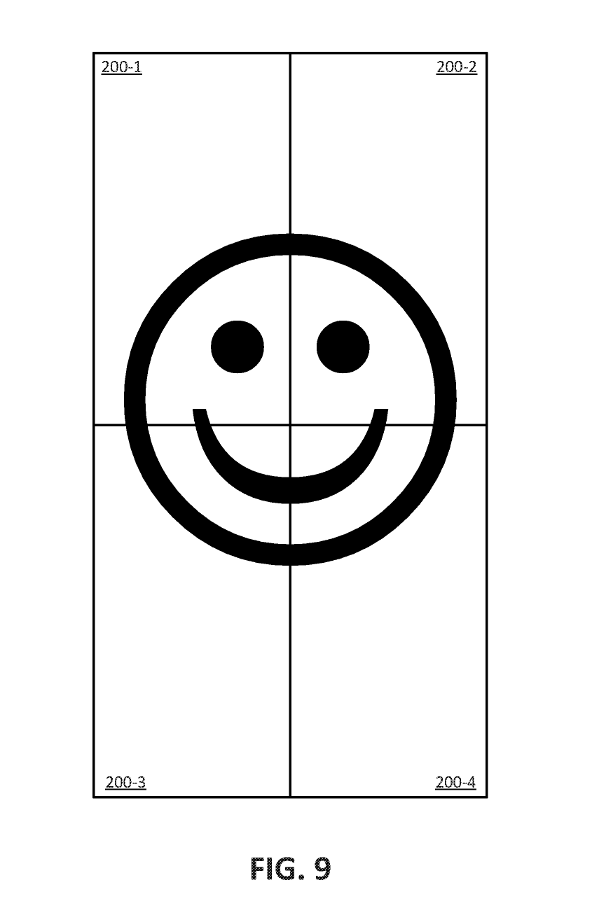

FIG. 9 shows four interconnected host/slave devices 200, namely, devices 200-1, 200-2, 200-3, and 200-4, according to an embodiment. In this embodiment, each of the host/slave devices may be smart phone, a tablet computer, or the like, and may each include a conventional display (e.g., an LED display or an LCD display). As depicted, the devices 200 are connected in a 2×2 matrix arrangement using a suitable combination of device ports 210, e.g., located at the edges of devices 200.

As shown, devices 200 may cooperate to operate in concert, e.g., to display an image spanning each display.

In this example, device 200-1 may be assigned to be the host device, and devices 200-2, 200-3, and 200-4 may be assigned to be slave devices (e.g., slaves of device 200-1).

As host, device 200-1 may store the image data; transmit image data corresponding to an image quadrant to a respective one of device 200-2, 200-3, 200-4; and instructs the 200-2, 200-3, 200-4 to display the transmitted image data.

The particular device 200 assigned to be the host device may be established following negotiation between the devices. In one example, the role of host may be assigned based on which device 200 stores the desired data. In another example, the role of host may be assigned based on which device 200 has the best network connectivity for downloading data. In another example, the role of host may be assigned based on which device 200 has the highest battery life.

In a similar manner, devices 200 may cooperate to process and/or present other forms of data. For example, videos may also be displayed across multiple displays. Devices 200 may also cooperate to perform other functions in which a host device may control one or more slave devices. Slave devices may be assigned disparate tasks. For example, a particular slave device may be assigned to download data, another slave device may be assigned to display that data, another slave device may be assigned to archive that data, and another slave device may be assigned to supply power to interconnected devices (e.g., by way of their USB interfaces).

Although embodiments have been described in the foregoing with reference to ports, links, interfaces, and devices configured to communicate according to a USB standard, in other embodiments, the components described herein may be configured to communicate according to other standards and protocols such as, e.g., Firewire, SATA/PATA, or the like. The components may described herein may also be configured to communicate according to various standards and protocols for network communication.

The embodiments of the devices, systems and methods described herein may be implemented in a combination of both hardware and software. Some embodiments may be implemented on programmable computers, each computer including at least one processor, a data storage system (including volatile memory or non-volatile memory or other data storage elements or a combination thereof), and at least one communication interface.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only. The scope is indicated by the appended claims.

What is claimed is:

1. A communication controller for an electronic device, comprising:
a hub controller;
an internal port for connecting to an I/O interface of said electronic device;
at least two external ports for connection to external electronic devices by way of corresponding connectors on a housing of said electronic device;
a switching circuit for selectively connecting a device at any given one of said internal port and said external ports, as a host device, with other devices at remaining ones of said internal and external ports as slave devices;
wherein said switching circuit is configured to switch between:
a first state in which said switching circuit connects said electronic device at said internal port as a host device with a first external device at a first one of said external ports as a slave device, and with a second external device at a second one of said external ports as a slave device;
a second state in which said switching circuit connects said first external device at said first one of said external ports as a host device, with said electronic device at said internal port as a slave device, and with said second external device at said second one of said external ports as a slave device; and
a third state in which said switching circuit connects said second external device at said second one of said external ports as a host device, with said electronic device at said internal port as a slave device, and with said first external device at said first one of said external ports as a slave device; and
a control input for receiving a control signal from a processor of said electronic device to select one of said first, second and third states.

2. The communication controller of claim 1, wherein said plurality of secondary internal ports comprise a USB port.

3. The communication controller of claim 1, wherein said plurality of secondary internal ports comprise a Firewire port.

4. The communication controller of claim 1, wherein the control signal is received by way of a wireless interface.

5. The communication controller of claim 1, wherein said control input is configured to receive said control signal from a general purpose input-output (GPIO) pin on a processor of the electronic device.

6. The communication controller of claim 1, wherein said hub controller comprises control logic for selecting said first one of said internal port and said external ports based on said control signal and signals received by way of said ports.

7. The communication controller of claim 6, wherein said control logic is operable to re-select said first one of said internal port and said external ports without connecting or disconnecting a device from any of said ports.

8. The communication controller of claim 7, wherein said control logic is operable to re-select said first one of said internal port and said external ports based on said control signal.

9. The communication controller of claim 7, wherein said control logic is operable to re-select said first one of said internal port and said external ports based on said control signal.

10. The communication controller of claim 1, wherein said electronic device is a smart phone.

11. A method of operating a communication hub of an electronic device, comprising;
connecting a plurality of external devices to said communication hub;
receiving a control input from a processor of said electronic device;
assigning, based on said control input, said electronic device or one of said plurality of external devices as a host;
assigning the others of said electronic device and said plurality of electronic devices as slaves;
connecting said slaves in communication with said host by way of a switching circuit.

12. The method of claim 11, wherein said communication hub is a USB hub.

13. The method of claim 11, wherein said communication hub is a firewire hub.

14. The method of claim 11, comprising receiving said control input by way of a wireless interface.

15. The method of claim 11, comprising receiving said signal from a general purpose input-output pin of said processor.

16. The method of claim 11, wherein said assigning is based on said control input and data received from said external devices at said hub.

17. The method of claim 11, comprising re-assigning said electronic device or one of said plurality of external devices as a host without connecting or disconnecting an external device from said electronic device.

18. An electronic device comprising the communication controller of claim 1.

19. A smartphone comprising the communication controller of claim 1.

20. A communication controller for an electronic device, comprising:
a hub controller;
an internal port for connection to an I/O interface of said electronic device;
a plurality of external ports for connection to external electronic devices by way of corresponding connectors on a housing of said electronic device;
a switching circuit for selectively connecting a device at any first one of said internal port and said external ports, as a host device, with another device at any second one of said internal and external ports as a slave device; and
a control input for receiving a control signal from a processor of said electronic device for selection of said first one of said internal port and said external ports.

21. The communication controller of claim 20, wherein said switching circuit is operable to connect a device at one of said external ports as a host device, and devices at said internal port and at least one of said external ports as slave devices.
